(19) United States
(12) Patent Application Publication
(10) Pub. No.: US 2015/0193061 A1
(43) Pub. Date: Jul. 9, 2015

(54) USER'S COMPUTING EXPERIENCE BASED ON THE USER'S COMPUTING ACTIVITY

(71) Applicant: Google Inc., (US)

(72) Inventors: Zoltan Stekkelpak, Sunnyvale, CA (US); Artem Chetverykov, Mountain View, CA (US)

(73) Assignee: Google Inc., Mountain View, CA (US)

(21) Appl. No.: 13/753,430

(22) Filed: Jan. 29, 2013

(51) Int. Cl. G06F 3/048

(52) U.S. Cl. CPC G06F 3/048

(57) ABSTRACT

Systems and methods for improving a user's computing experience based on the user's computing activity are provided. In some aspects, a method includes receiving an indication of a first computing activity by a user on a computing device and receiving an indication of a second computing activity by the user on the computing device. The method also includes determining a point with respect to the first computing activity that corresponds to a change in an attention of the user from the first computing activity to the second computing activity. The method also includes storing a marker in a memory based on the determined point. The marker is configured to be accessed to resume the first computing activity at the point corresponding to the change in the user's attention from the first computing activity to the second computing activity.

### FIELD

The subject technology generally relates to user computing and, in particular, relates to systems and methods for improving a user's computing experience based on the user's computing activity.

### BACKGROUND

Computer users may engage in multiple computer activities at the same time. For example, a user may work on a document using a word processing application, as well as work on a spreadsheet using a spreadsheet processing application. Computer users may also perform tasks while consuming content. As an example, a user may watch a video embedded within a webpage, and while that video is playing, the user may also read text on the webpage or view images on the webpage. However, when a user switches from one computing activity to another, it may be inconvenient or difficult for the user to resume or continue engaging in the previous computing activity.

### SUMMARY

According to various aspects of the subject technology, a computer-implemented method of improving a user's computing experience based on the user's computing activity is provided. The method comprises receiving an indication of a first computing activity by a user on a computing device and receiving an indication of a second computing activity by the user on the computing device. The method also comprises determining a point with respect to the first computing activity that corresponds to a change in an attention of the user from the first computing activity to the second computing activity. The method also comprises storing a marker in a memory based on the determined point. The marker is configured to be accessed to resume the first computing activity at the point corresponding to the change in the user's attention from the first computing activity to the second computing activity.

According to various aspects of the subject technology, a machine-readable storage medium comprising machine-readable instructions causing a processor to execute a method for improving a user's computing experience based on the user's computing activity is provided. The method comprises receiving an indication of a first computing activity by a user on a computing device. The first computing activity relates to a consumption of a first multimedia content. The method also comprises receiving an indication of a second computing activity by the user on the computing device, and determining a point with respect to the first multimedia content that corresponds to a change in an attention of the user from the consumption of the first multimedia content to the second computing activity. The method also comprises storing a marker in a memory based on the determined point. The marker is configured to be accessed to resume the consumption of the first multimedia content at the point corresponding to the change in the user's attention from the consumption of the first multimedia content to the second computing activity.

According to various aspects of the subject technology, a system for improving a user's computing experience based on the user's computing activity. The system comprises a memory comprising instructions for improving a user's computing experience based on the user's computing activity. The system also comprises a processor configured to execute the instructions to receive a first indication of a first computing activity by the user on a first computing device and to receive a second indication of a second activity by the user. The processor is also configured to execute the instructions to determine, based on at least one of the first indication of the first computing activity or the second indication of the second activity, a point with respect to the first computing activity that corresponds to a change in an attention of the user from the first computing activity on the first computing device to the second activity. The processor is also configured to execute the instructions to store a marker in a memory based on the determined point. The marker is configured to be accessed to resume the first computing activity at the point corresponding to the change in the user's attention from the first computing activity to the second activity.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of an environment in which a user may conveniently resume, suspend, and/or continue engaging in a first computing activity after the user switches to a second computing activity, in accordance with various aspects of the subject technology.

FIGS. 2A and 2B illustrate examples of computing activities by a user, in accordance with various aspects of the subject technology.

FIGS. 3A and 3B illustrate examples of graphical user interfaces, in accordance with various aspects of the subject technology.

FIGS. 4A, 4B, 4C, and 4D illustrate examples of computing activities by a user, in accordance with various aspects of the subject technology.

FIGS. 5A and 5B illustrate an example of an application for engaging in a first computing activity and a second computing activity, in accordance with various aspects of the subject technology.

FIGS. 6A and 6B illustrate examples of markers, in accordance with various aspects of the subject technology.

FIG. 7 conceptually illustrates an electronic system with which any implementations of the subject technology are implemented.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

According to various aspects of the subject technology, systems and methods for improving a user's computing experience based on the user's computer activity are provided. In some aspects, systems and methods are provided for allowing a user to conveniently resume, suspend, and/or continue engaging in a first computing activity when the user switches from the first computing activity to a second computing activity.

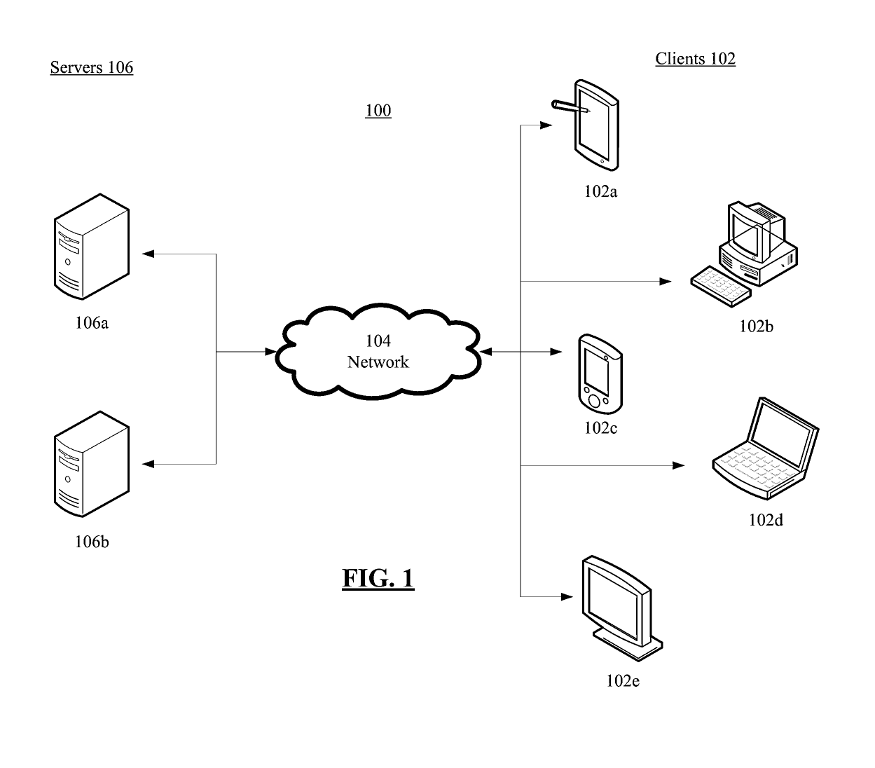

FIG. 1 illustrates an example of environment 100 in which a user may conveniently resume, suspend, and/or continue engaging in a first computing activity after the user switches to a second computing activity, in accordance with various aspects of the subject technology. Environment 100 includes servers 106 (e.g., servers 106a and 106b) and client devices 102 (e.g., client devices 102a, 102b, 102c, 102d, and 102e) connected over network 104. Network 104 can include, for example, any one or more of a personal area network (PAN), a local area network (LAN), a campus area network (CAN), a metropolitan area network (MAN), a wide area network (WAN), a broadband network (BBN), a peer-to-peer network, an ad-hoc network, the Internet, and the like. Furthermore, network 104 can include, but is not limited to, any one or more network topologies such as a bus network, a star network, a ring network, a mesh network, a star-bus network, tree or hierarchical network, and the like.

The user may engage in one or more computing activities using client devices 102 and/or servers 106. Each client device 102 or server 106 can be any electronic device having processing hardware, memory, and communications capability necessary to perform some or all of the operations disclosed herein. Client devices 102, for example, can be desktop computers (e.g., client device 102b), mobile computers (e.g., client device 102d), tablet computers (e.g., including e-book readers such as client device 102a), mobile devices (e.g., smartphones or personal digital assistants such as client device 102c), televisions (e.g., with one or more processors coupled thereto and/or embedded therein such as client device 102e), set top boxes, video game consoles, smart glasses, smart watches, augmented reality devices, or any other electronic devices having memory, processing hardware, and communications capabilities for allowing the user to resume, suspend, or continue engaging in a first computing activity after the user switches to a second computing activity.

In some aspects, a method includes receiving an indication of a first computing activity by a user on client device 102. The first computing activity can be, for example, editing a document, viewing a video or image, reading text, playing a game, playing a slideshow, and/or another suitable activity using client device 102. In some aspects, the first computing activity may involve communicating with a server 106 over network 104. For example, the first computing activity may involve receiving a video at client device 102 from server 106 over network 104 so that the user may view the video on client device 102.

According to certain aspects, the method further includes receiving an indication of a second computing activity by the user on the client device 102. Similar to the first computing activity, the second computing activity can be, for example, editing a document, viewing a video or image, reading text, playing a game, playing a slideshow, and/or another suitable activity using client device 102. However, it should be noted that the first computing activity and the second computing activity may or may not be interrelated. For example, the first computing activity and the second computing activity may be performed within a single application, within two separate applications, or an application and an operating system.

In some aspects, the first computing activity and the second computing activity may be performed on separate client devices 102. For example, a first computing activity can involve the user viewing a video on client device 102b, and a second computing activity can involve the user receiving or making a phone call on client device 102c. Even though the first computing activity and the second computing activity may be on separate client devices 102, it can be determined that the second computing activity on client device 102c and the first computing activity on client device 102b are associated with the same user, especially if the user is signed into both client devices 102b and 102c (e.g., for different services). For example, the user may sign in to client device 102b using a first set of authentication credentials (e.g., username, password, etc.) for a first service (e.g., a video service that provides online videos). A server providing the first service (e.g., server 106a or 106b) may verify the first set of authentication credentials and allow the user to sign in. The user may also sign in to client device 102c using a second set of authentication credentials (e.g., username, password, etc.) for a second service (e.g., a mobile operating system for a smartphone). A server providing the second service (e.g., server 106a or 106b) may verify the second set of authentication credentials and allow the user to sign in. According to certain aspects, the first set of authentication credentials can be correlated with the second set of authentication credentials. For example, if the first service and the second service are both provided by the same server and/or are otherwise related such that it can be determined that the same user is using both the first service and the second service, then the first set of authentication credentials can be correlated with the second set of authentication credentials. Based on such a correlation, it can be determined that the same user signed into both client device 102b and 102c.

In another example, a first computing activity can involve the user viewing a video embedded in a web page, and a second computing activity can involve the user reading text on the same web page. According to certain aspects, it should be noted that regardless of whether the user engages in the first computing activity and the second computing activity within an application or an operating system, they need not necessarily be engaged in two different tabs or windows. That is, the distinction between the first computing activity and the second computing activity need not be based solely on whether a graphical user interface window or tab is active, inactive, in the background, or the foreground.

As discussed above, the method provided by aspects of the subject technology allows the user to conveniently resume, suspend, and/or continue engaging in a first computing activity after the user switches to a second computing activity. For example, assume the first computing activity involves the user watching a video on his smartphone (e.g., client device 102c), and assume that a second computing activity involves the user receiving a phone call on the smartphone from his friend. When the user receives the phone call, the video may be paused so that the user will not miss any part of the video. In some aspects, when the user receives the phone call, a notification (e.g., a message, an icon, etc.) may be displayed to let the user know that the video will pause and that the user will not miss any part of the video.

According to certain aspects, if the second computing activity is predictable, the first computing activity may be suspended even before the second computing activity occurs. Following the previous example, the video on the user's smartphone may be paused before the user receives the phone call (e.g., the video may be paused when the user's friend initiates the phone call). In this situation, the notification may also be displayed before the user receives the phone call to let the user know that the video will pause and that the user will not miss any part of the video.

According to certain aspects, a method is also provided to delay or prevent the second computing activity from occurring (e.g., if the first computing activity is a high priority activity that the user would not want to be interrupted). The priority of the first computing activity and/or the second computing activity may be predetermined or the user may be allowed to indicate which activity has higher priority over the other. According to certain aspects, depending on which computing activity has higher priority, the second computing activity may either (i) be delayed or prevented from occurring, or (ii) be allowed to occur. For example, if the second computing activity has higher priority than the first computing activity, the second computing activity may be allowed to occur. If the second computing activity has lower priority than the first computing activity, the second computing activity may be delayed or prevented from occurring. For example, assume that the first computing activity involves the user playing an online game using a desktop computer (e.g., client device 102b), which has been determined to be high priority. Furthermore, assume that a second computing activity involves the user receiving a phone call on his smartphone (e.g., client device 102c) from an acquaintance, which has been determined to be low priority. Thus, should the acquaintance attempt to call the user on his smartphone, the call may be prevented or delayed since the user is still playing the online game, which has higher priority. According to certain aspects, a notification (e.g., a message, text, etc.) may be delivered to the acquaintance to inform the acquaintance that the user cannot receive the phone call at the moment.

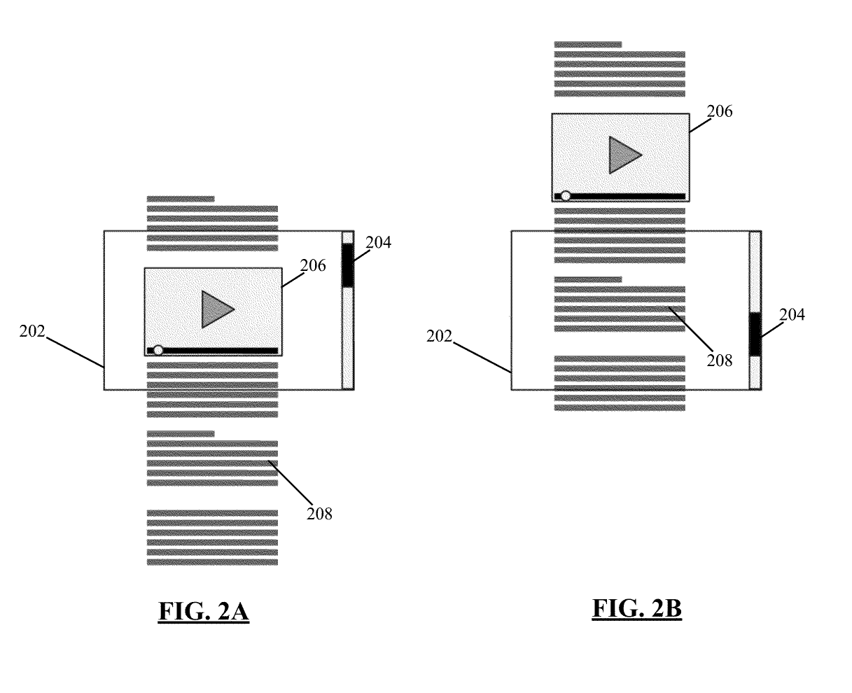

FIG. 2A illustrates an example of a first computing activity by a user, while FIG. 2B illustrates an example of a second computing activity by the user, in accordance with various aspects of the subject technology. As shown in these figures, application 202 is used to view a webpage that includes video 206 (e.g., embedded in the webpage) and text 208. The first computing activity by the user is related to a consumption of video 206, while the second computing activity is related to the reading of text 208. However, as discussed above, the first computing activity and the second computing activity may be any activity, including, but not limited to, editing a document, viewing an image, playing a game, playing a slideshow, and/or another suitable activity using a computing device.

Application 202 may represent a browser, a window, or any other suitable mechanism for displaying content to a user. Content within the border of application 202 is visible to the user, while content that is outside of the border of application 202 is not visible to the user. Scroll bar 204 provides an indication of which part of the webpage is currently visible to the user within the border of application 202. For example, as shown in FIG. 2A, video 206 is visible to the user while text 208 is not. If the user scrolls down the webpage, the user can switch from the first computing activity (e.g., consuming video 206) to the second computing activity (e.g., reading text 208, which is now visible within the border of application 202, as shown in FIG. 2B).

As discussed above, when the user switches from the first computing activity to the second computing activity, aspects of the subject technology provide a method to resume, suspend, and/or continue engaging in the first computing activity. For example, in FIGS. 2A and 2B, video 206 may be paused when the user scrolls down the webpage to read text 208 and video 206 is no longer visible to the user. In some aspects, however, the user may desire to continue playing video 206 even though the user is currently reading text 208. This may be because video 206 may be a music video, and the user is interested in listening to the music associated with video 206 while reading text 208. Alternatively, video 206 may have audio that is related to text 208, and the user may wish to read text 208 as well as listen to the audio of video 206 at the same time.

According to certain aspects, when the user switches to the second computing activity (e.g., reading text 208), different actions may be taken depending on whether the first computing activity (e.g., viewing video 206 or any other multimedia content) is associated with a viewing-based category or a non-viewing-based category. Multimedia content that is associated with a viewing-based category may include content that primarily requires a user to view the content in order to consume the content. For example, movies, television shows, pictures, and/or other similar content may be associated with a viewing-based category. Multimedia content that is associated with a non-viewing-based category may include content that does not primarily require a user to view the content in order to consume the content. For example, audio, music videos, videos that only have an audio component, videos of newscasters that only read the news, and/or other similar content may be associated with a non-viewing-based category. Whether multimedia content is associated with a viewing-based category or a non-viewing-based category can be determined by analyzing the content's previous consumption patterns. For example, if a video was played predominantly in the background (e.g., not visible to the user), the video is more likely to be associated with a non-viewing-based category. However, if a video was played predominantly when it was visible to the user, then this video is more likely to be associated with a viewing-based category.

Depending on whether video 206 is associated with a viewing-based category or a non-viewing-based category, video 206 may either be suspended or allowed to be played when the user scrolls down the webpage to read text 208. For example, if video 206 is associated with a viewing-based category, video 206 may be suspended when the user scrolls down to read text 208 (e.g., since the user would not be able to view video 206 anyway). If video 206 is associated with a non-viewing-based category, video 206 may continue to play when the user scrolls down to read text 208 (e.g., so that the user may listen to the audio associated with video 206).

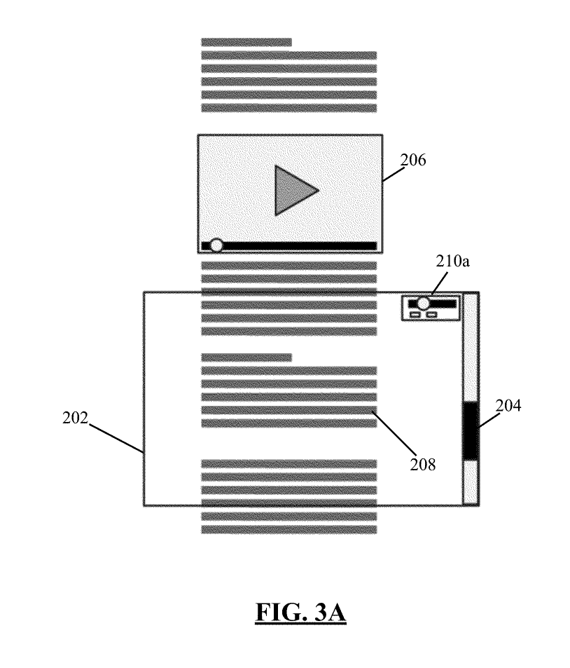

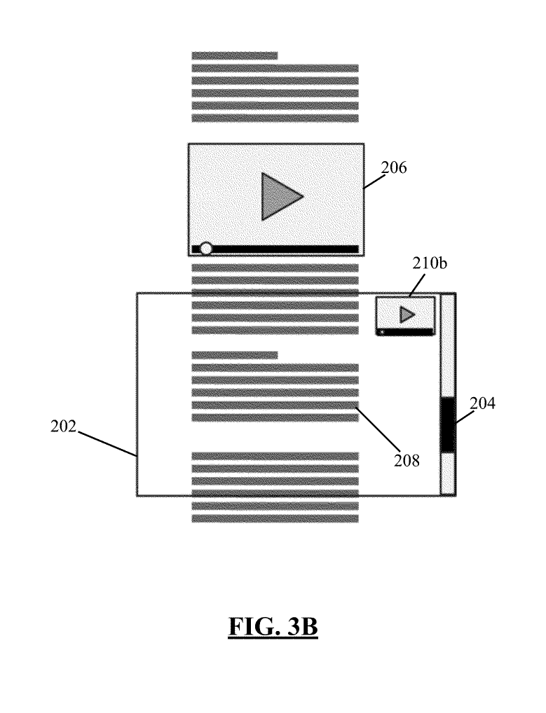

According to various aspects of the subject technology, a graphical user interface is provided to allow a user to continue engaging in a first computing activity even when the user is engaged in a second computing activity. FIGS. 3A and 3B illustrate an example of such a graphical user interface (e.g., illustrated as graphical user interface 210a in FIGS. 3A and graphical user interface 210b in FIG. 3B), in accordance with various aspects of the subject technology.

As shown in FIG. 3A, graphical user interface 210a is visible when the user is reading text 208 (e.g., graphical user interface 210a is mounted to one location relative to application 202). Graphical user interface 210a provides a control for the user to control playback and other settings associated with video 206. For example, using graphical user interface 210a, the user may be able to skip forward to a different part of video 206, pause video 206, resume video 206, adjust the volume of the audio associated with video 206, and/or control other settings associated with video 206. According to certain aspects, graphical user interface 210a may be provided in response to the user engaging in the second computing activity. In some aspects, graphical user interface 210a may be provided depending on whether video 206 is associated with a viewing-based category or a non-viewing based category. For example, graphical user interface 210a may be provided if video 206 is associated with a non-viewing-based category, and not provided if video 206 is associated with a viewing-based category. In such a situation, for example, graphical user interface 210a may be provided to the user so that the user can control playback of the audio associated with video 206.

As shown in FIG. 3B, graphical user interface 210b is visible when the user is reading text 208 (e.g., graphical user interface 210b is mounted to one location relative to application 202). Graphical user interface 210b provides a miniature view of video 206. Thus, graphical user interface 210b allows the user to continue watching video 206 (e.g., via the miniature view of video 206) while reading text 208 at the same time. According to certain aspects, graphical user interface 210b may be provided in response to the user engaging in the second computing activity. In some aspects, graphical user interface 210b may be provided depending on whether video 206 is associated with a viewing-based category or a non-viewing based category. For example, graphical user interface 210b may be provided if video 206 is associated with a viewing-based category, and not provided if video 206 is associated with a non-viewing-based category. In such a situation, for example, graphical user interface 210b may be provided to the user so that the user can continue watching the miniature view of video 206.

Although graphical user interface 210a and 210b are described separately, it is understood that a graphical user interface that includes both features of graphical user interface 210a and 210b can be provided (e.g., a graphical user interface that provides both a view of video 206 as well as control of video 206). Furthermore, aspects of the subject technology may not only provide a graphical user interface that allows a user to continue engaging in the first computing activity, but also a graphical user interface that allows the user to monitor multiple computing activities, switch between the multiple computing activities, and/or determine which computing activity has not yet been completed. Such a graphical user interface, for example, can remain visible to the user (or at least be displayed when requested by the user) so that the user can switch between the multiple computing activities and/or determine which computing activity has not yet been completed. Such activities, for example, may include online videos not yet finished, image albums not yet viewed until the end, articles not yet read entirely, phone calls that were interrupted, etc. The graphical user interface may, for example, act as a dashboard that can list the multiple computing activities, display snapshots/icons of applications associated with the computing activities, provide user interface elements (e.g., buttons, keyboard combinations, etc.) that allow the user to resume and/or switch to certain activities, provide settings that allow the user to prioritize certain activities, and/or other suitable perform other actions that allow the user to manage the multiple computing activities.

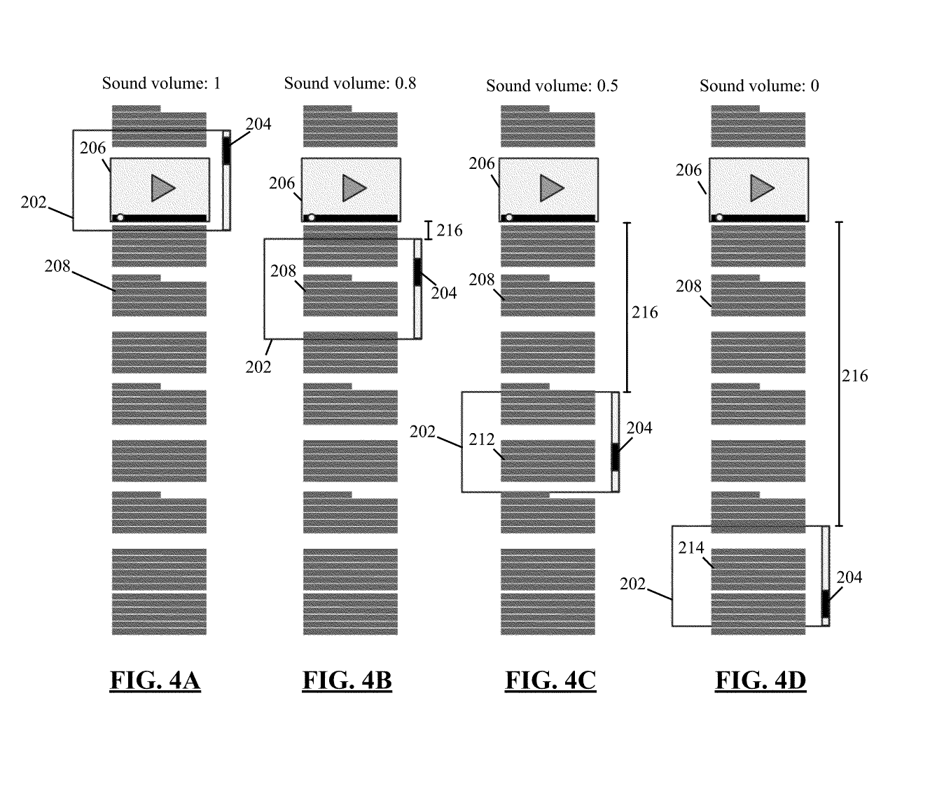

According to various aspects of the subject technology, at least one aspect of the first computing activity may be altered when the user switches from the first computing activity to the second computing activity, thereby providing the user with an indication of how far removed the user is from the first computing activity. FIGS. 4A, 4B, 4C, and 4D illustrate an example of at least one aspect of the first computing activity being altered in this manner, in accordance with various aspects of the subject technology. As shown in these figures, application 202 is used to view a webpage that includes video 206 (e.g., embedded in the webpage), text 208, text 212, and text 214. In particular, FIGS. 4A, 4B, 4C, and 4D illustrate the user scrolling down the webpage to initially view video 206, followed by text 208, followed by text 212, and then followed by text 214. The first computing activity by the user is related to a consumption of video 206, as illustrated in FIG. 4A. FIG. 4B illustrates the second computing activity as the user reading text 208, FIG. 4C illustrates the second computing activity as the user reading text 212, and FIG. 4D illustrates the second computing activity as the user reading text 214.

As the user scrolls farther down the webpage away from video 206, distance 216 of application 202 from video 206 grows larger. Furthermore, a sound output level of video 206 progressively becomes lowered, thereby providing an indication to the user that video 206 is being moved farther away from the current view of the webpage. For example, the sound output level of video 206 may be at 100% in FIG. 4A, 80% in FIG. 4B, 50% in FIG. 4C, and 0% in FIG. 4D. Although the sound output level of video 206 is described as being one aspect that can be altered, other aspects of video 206 can be altered as well, such as a sound quality of video 206 and/other other aspects of video 206 that are useful for providing an indication to the user of how far removed the user is from the first computing activity. For example, if the sound quality of video 206 is altered, a background and/or echo effect may be progressively applied to the audio of video 206. According to certain aspects, if video 206 is associated with a non-viewing-based category, then the sound output level and/or sound quality may not be altered when the user scrolls down the webpage away from video 206.

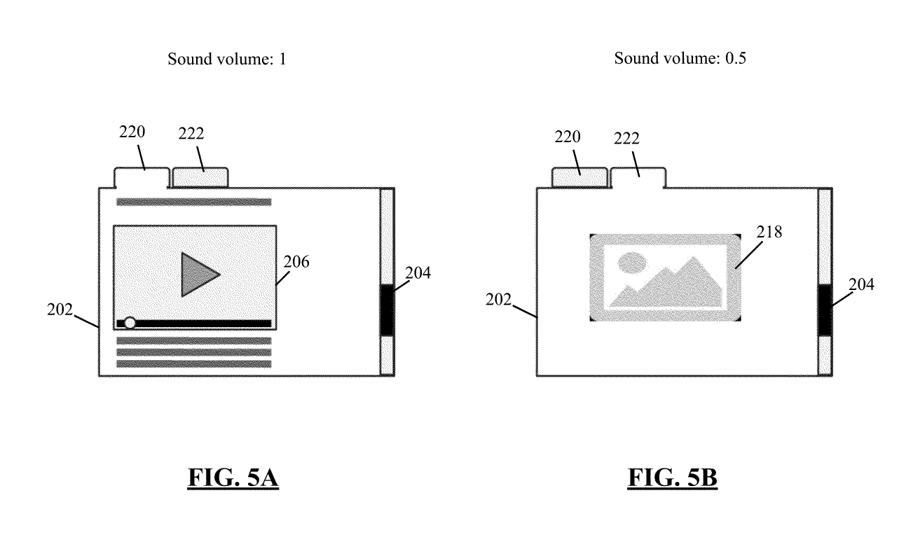

Although FIGS. 4A, 4B, 4C, and 4D describe one or more aspects of video 206 being altered based on a distance that the user has scrolled away from the first computing activity, the one or more aspects of video 206 may also be altered based on a relative position of a tab of a browser used for the first computing activity and the second computing activity. FIGS. 5A and 5B illustrate application 202 as a browser used for a first computing activity and a second computing activity, in accordance with various aspects of the subject technology. Application 202 comprises first tab 220 and second tab 222. Assume that the first computing activity involves the user viewing video 206 on first tab 220, and that the second computing activity involves the user viewing image 218 on second tab 222.

According to certain aspects, as the user switches from first tab 220 to second tab 222 to view image 218, a sound output level of video 206 may be lowered, thereby providing an indication to the user that video 206 is being moved farther away from an active tab that is being viewed by the user (e.g., second tab 222). For example, the sound output level of video 206 may be at 100% in FIG. 5A when the user is viewing video 206, but may be lowered to 50% when the user switches to tab 222 to view image 218 in FIG. 5B. Although FIGS. 5A and 5B only illustrate two tabs (e.g., tab 220 and 222), the sound output level may be similarly lowered when application 202 comprises more than two tabs. In this situation, the sound output level may also be progressively altered depending on the relative position of the active tab (e.g., the farther the active tab is away from first tab 220, the lower the sound output level).

Furthermore, although the sound output level of video 206 is described as being one aspect that can be altered when the user switches between different tabs, other aspects of video 206 can be altered, such as a sound quality of video 206 and/other aspects of video 206 that are useful for providing an indication to the user of how far removed the user is from the first computing activity. For example, if the sound quality of video 206 is altered, a background and/or echo effect may be progressively applied to the audio of video 206. According to certain aspects, if video 206 is associated with a non-viewing-based category, then the sound output level and/or sound quality may not be altered when the user switches to a tab different from one that is used to view video 206.

Aspects of the subject technology also enable a user to conveniently resume the first computing activity when the user switches from the first computing activity to the second computing activity. For example, a method includes determining a point with respect to the first computing activity that corresponds to a change in an attention of the user from the first computing activity to the second computing activity. Such a point, for example, may be before, at, or after the change in the user's attention from the first computing activity to the second computing activity. The point can be determined based on whether the first computing activity and/or the second computing activity are visible to the user. In some aspects, the point can be determined based on input(s) and/or indications received from a computing device (e.g., client device 102 and/or server 106).

The point can be expressed as a temporal value. That is, the point can be referenced based on a measurement of time. For example, a time reported by an operating system on client device 102 can be used to express the point. As another example, a clock timer can be started at the point, in which case, the point may be considered time zero. In short, any approach to expressing the point that is rooted in time can be used.

The point can also be expressed as a value corresponding to a progress of the first computing activity. The progress can be based on any aspect of the first computing activity that changes over time, or in the course of engaging in the first computing activity. For example, when the first computing activity corresponds to viewing a video, the point can be expressed as an elapsed time of the video, a remaining time of the video, a percentage of the video that has been viewed, a frame number of the video, and so on. As another example, when the first computing activity corresponds to viewing a presentation, the point can be expressed using a slide number, or a time or percentage of the slideshow corresponding to the presentation. Similarly, when the first computing activity corresponds to editing a document in a word processing application, the point can be expressed using a page number, paragraph number, line number, and so on. As yet another example, when the first computing activity corresponds to reading a document, the point can be expressed using a position of the scroll bars, the portion of the document that is visible, and so on. Expression of the point is not limited to the preceding examples. Any combination of the above can be used, or any other approach, can be taken. For example, a log of computing activity (e.g., system events, application events, security events) that is maintained by an operating system on the computing device can be used.

The method further includes storing a marker in a memory based on the determined point. According to certain aspects, the marker is configured to be accessed to resume the first computing activity at the point corresponding to the change in the user's attention from the first computing activity to the second computing activity. In some aspects, the marker brings the user back to the point with respect to the first computing activity, when the user changed the focus of his attention to the second computing activity. The manner in which the marker is implemented may be based upon the nature of the first computing activity. For example, when the first computing activity corresponds to viewing a video, the marker can be a shortcut to the point in the video when the user changed his attention to the second computing activity. In some aspects, the point can be before a time when the user changed his attention to the second computing activity so that when the user resumes watching the video, the user can re-watch a portion of the video right before his attention was shifted (e.g., as a brief recap of the video). In some aspects, the point can be after a time when the user changed his attention to the second computing activity, which may be useful for skipping a commercial block or an undesired portion of the video.

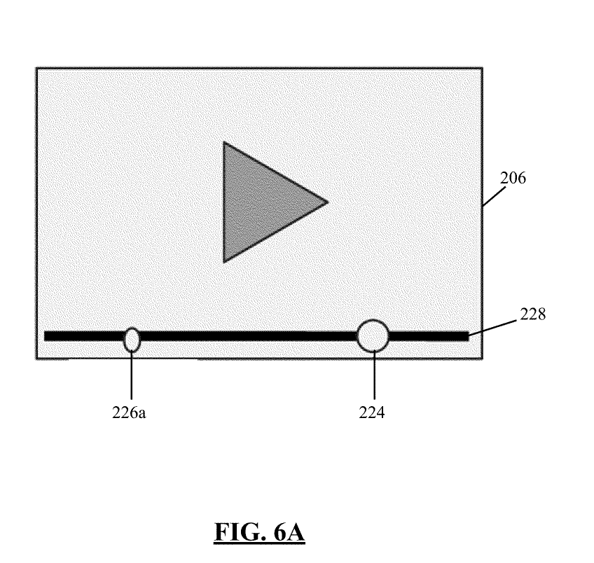

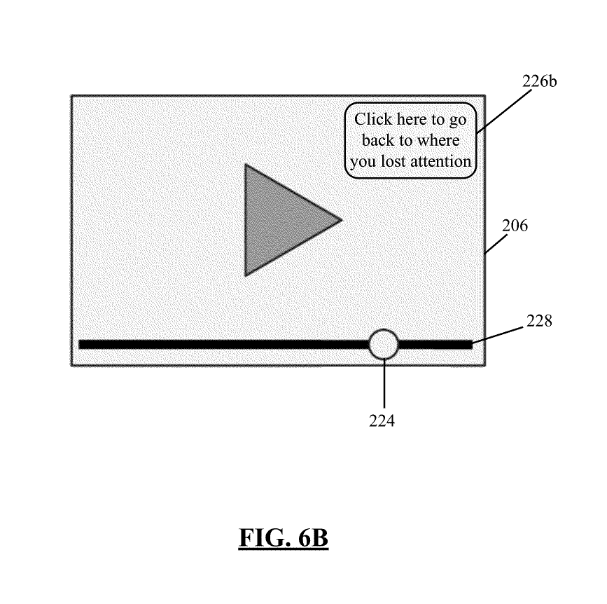

FIGS. 6A and 6B illustrate examples of a marker (shown as marker 226a in FIG. 6A and marker 226b in FIG. 6B), in accordance with various aspects of the subject technology. For example, as shown in FIG. 6A, video 206 includes progress bar 228 and play indicator 224. The position of play indicator 224 on progress bar 228 shows which part of video 206 is currently being played. According to certain aspects, marker 226a is located on a position of progress bar 228 in order to let the user know at which point the user lost attention of video 206. In this way, the user can resume video 206 at the point in which he lost attention by clicking on progress bar 228 at marker 226a. Alternatively, as shown in FIG. 6B, marker 226b may be a button that the user can click on to return the user to the point in video 206 when the user lost attention.

Although the marker is described as being located on a position of a progress bar or as a button, the marker may be implemented in other ways. According to certain aspects, the marker may be stored as a visual representation of a shift, of the user, from the first computing activity to the second computing activity, thereby reminding the user of how the user switched from the first computing activity to the second computing activity. In some aspects, the visual representation may comprise a static image (e.g., an icon, a screenshot, etc.) that corresponds to an application used to perform the first computing activity and/or the second computing activity. For example, if the first computing activity involves the user viewing a video (and a video application is used to view the video) and the second computing activity involves the user editing a document (and a word processing application is used to edit the document), the visual representation may be an icon of the video application with an arrow pointing to an icon of the word processing application. Thus, when such a visual representation is displayed to the user, the user would know that he switched from viewing the video to editing the document. In some aspects, the visual representation may comprise a moving image (e.g., an animation, a video, etc.) corresponding to the user's shift from the first computing activity to the second computing activity.

Although the second computing activity is described herein, an activity that the user switches to from the first computing activity is not limited to computing activities, but may also include any activity that the user may engage in or any activity that may distract the user from the first computing activity. For example, the first computing activity may involve the user watching an online video on a computer, and the second activity may be the user losing Wi-Fi connection on the computer. In such a case, a marker may be used to indicate which point in the online video that the user lost the Wi-Fi connection. In another example, the first computing activity may involve the user talking on a smartphone, while the second activity may be the user being distracted by surrounding noise. In this case, the sound output level of the smartphone can be increased in response to the distraction. In another example, the first computing activity may involve the user watching a video on a television connected to the internet, and the second activity may be the user speaking to someone else (e.g., which can be detected by a microphone of the television). In this case, the video on the television may pause or otherwise provide a marker to let the user know at which point the user lost attention and started speaking to someone else.

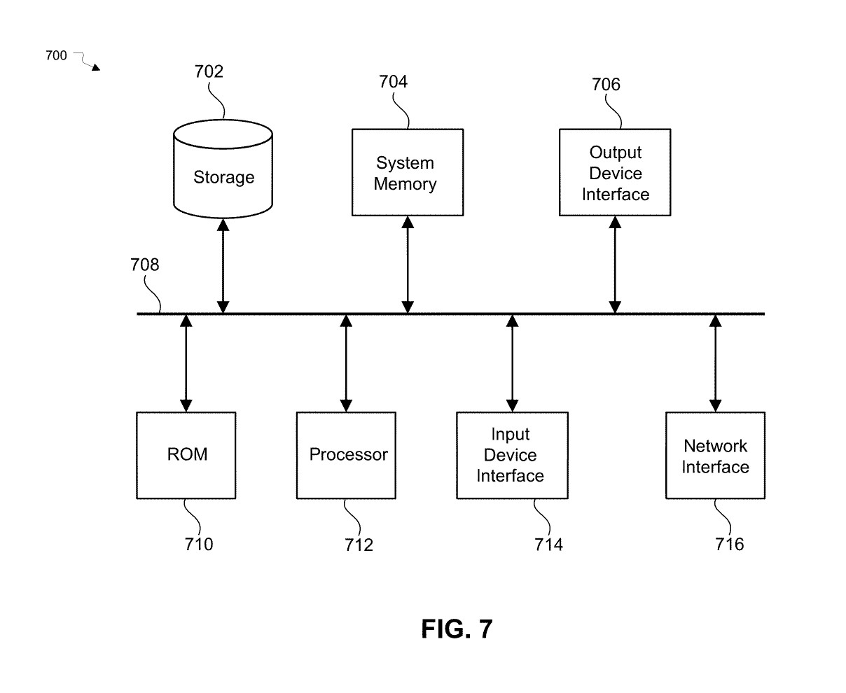

FIG. 7 conceptually illustrates electronic system 700 with which any implementations of the subject technology are implemented. Electronic system 700, for example, can be any client device or server as discussed herein, or generally any electronic device that transmits signals over a network. Such an electronic system includes various types of computer readable media and interfaces for various other types of computer readable media. Electronic system 700 includes bus 708, processing unit(s) 712, system memory 704, read-only memory (ROM) 710, permanent storage device 702, input device interface 714, output device interface 706, and network interface 716, or subsets and variations thereof.

Bus 708 collectively represents all system, peripheral, and chipset buses that communicatively connect the numerous internal devices of electronic system 700. In one or more implementations, bus 708 communicatively connects processing unit(s) 712 with ROM 710, system memory 704, and permanent storage device 702. From these various memory units, processing unit(s) 712 retrieves instructions to execute and data to process in order to execute the processes of the subject disclosure. The processing unit(s) can be a single processor or a multi core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. One or more implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such as random access memory. System memory 704 stores any of the instructions and data that processing unit(s) 712 needs at runtime. In one or more implementations, the processes of the subject disclosure are stored in system memory 704, permanent storage device 702, and/or ROM 710. From these various memory units, processing unit(s) 712 retrieves instructions to execute and data to process in order to execute the processes of one or more implementations.

Bus 708 also connects to input and output device interfaces 714 and 706. Input device interface 714 enables a user to communicate information and select commands to the electronic system. Input devices used with input device interface 714 include, for example, alphanumeric keyboards and pointing devices (also called “cursor control devices”). Output device interface 706 enables, for example, the display of images generated by electronic system 700. Output devices used with output device interface 706 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, bus 708 also couples electronic system 700 to a network (not shown) through network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to analyze and control an operation or a component may also mean the processor being programmed to analyze and control the operation or the processor being operable to analyze and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method of improving a user's computing experience based on the user's computing activity, the method comprising:
receiving an indication of a first multimedia content being in a visible area of a display device associated with a computing device, wherein a first computing activity by a user on the computing device relates to a consumption of the first multimedia content;
receiving an indication of the first multimedia content being moved away from the visible area of the display device;
receiving an indication of a second computing activity by the user on the computing device;
determining a point with respect to the first computing activity that corresponds to a change in an attention of the user from the first computing activity to the second computing activity;
storing a marker in a memory based on the determined point, wherein the marker is configured to be accessed to resume the first computing activity at the determined point; and
altering an audio component associated with the first multimedia content in response to a change in distance between the first multimedia content and the visible area of the display device based on the first multimedia content being moved away from the visible area of the display device.

2. The computer-implemented method of claim 1, wherein the point is expressed as at least one of a temporal value or a value corresponding to a progress of the first computing activity.

3. (canceled)

4. The computer-implemented method of claim 1, further comprising:
providing a graphical user interface for controlling the consumption of the first multimedia content, wherein the graphical user interface is visible for at least a portion of a duration of the second computing activity.

5. The computer-implemented method of claim 1, further comprising:
altering, based on a visibility of the first multimedia content, at least one aspect of the consumption of the first multimedia content.

6. The computer-implemented method of claim 5, wherein the at least one aspect comprises the audio component associated with the first multimedia content, the audio component comprising at least one of a sound output level corresponding to the first multimedia content or a sound quality corresponding to the first multimedia content.

7. (canceled)

8. The computer-implemented method of claim 1, wherein the audio component is progressively altered based on the change in the distance.

9. The computer-implemented method of claim 1, wherein an application used for the consumption of the first multimedia content comprises a plurality of tabs, and wherein the consumption of the first multimedia content corresponds to a first tab of the plurality of tabs, and wherein the method further comprises:
altering, based on a relative position of an active tab of the application, at least one aspect of the consumption of the first multimedia content.

10. The computer-implemented method of claim 9, wherein the at least one aspect is progressively altered based on the relative position.

11. The computer-implemented method of claim 1, further comprising:
determining whether the first multimedia content is associated with a viewing-based category or a non-viewing-based category; and
providing a graphical user interface for controlling the consumption of the first multimedia content based on a visibility of the first multimedia content and based on whether the first multimedia content is associated with the viewing-based category or the non-viewing-based category, wherein the graphical user interface is visible for at least a portion of a duration of the second computing activity.

12. The computer-implemented method of claim 11, wherein the determining of whether the first multimedia content is associated with the viewing-based category or the non-viewing-based category is based on previous consumption patterns of the first multimedia content.

13. The computer-implemented method of claim 1, further comprising:
determining whether the first multimedia content is associated with a viewing-based category or a non-viewing-based category; and
altering at least one aspect of the consumption of the first multimedia content based on a visibility of the first multimedia content and based on whether the first multimedia content is associated with the viewing-based category or the non-viewing-based category.

14. The computer-implemented method of claim 1, further comprising:
storing a visual representation of a shift, of the user, from the first computing activity to the second computing activity,
wherein:
the receiving the indication of the second computing activity comprises receiving an indication of a second multimedia content being in the visible area of the display device, and
the second computing activity relates to a consumption of the second multimedia content.

15. The computer-implemented method of claim 14, wherein the visual representation comprises a static image corresponding to an application used to perform the second computing activity, and wherein the image is at least one of an icon relating to the application or a screenshot of the application.

16. The computer-implemented method of claim 14, wherein the visual representation comprises a moving image corresponding to the user's shift from the first computing activity to the second computing activity.

17. The computer-implemented method of claim 1, further comprising suspending the first computing activity in response to receiving the indication of the second computing activity.

18. The computer-implemented method of claim 17, wherein the first computing activity is suspended before the user engages in the second computing activity.

19. The computer-implemented method of claim 17, further comprising providing an indication of the suspension of the first computing activity in response to receiving the indication of the second computing activity, wherein the indication of the suspension of the first computing activity is provided before the suspending.

20. The computer-implemented method of claim 1, further comprising delaying or preventing the second computing activity based on at least one of a priority of the first computing activity and a priority of the second computing activity.

21. The computer-implemented method of claim 20, further comprising determining the priority of the first computing activity and the priority of the second computing activity.

22. The computer-implemented method of claim 1, further comprising providing a graphical user interface for displaying a view relating to the first computing activity and for controlling the first computing activity.

23. The computer-implemented method of claim 1, wherein the point is before, at, or after the change in the user's attention from the first computing activity to the second computing activity.

24. A machine-readable storage medium comprising machine-readable instructions causing a processor to execute a method for improving a user's computing experience based on the user's computing activity, the method comprising:
receiving an indication of a first multimedia content being in a visible area of a display device associated with a computing device, wherein a first computing activity by a user on the computing device relates to a consumption of the first multimedia content;
receiving an indication of the first multimedia content being moved away from the visible area of the display device;
receiving an indication of a second computing activity by the user on the computing device;
determining a point with respect to the first multimedia content that corresponds to a change in an attention of the user from the consumption of the first multimedia content to the second computing activity;
storing a marker in a memory based on the determined point, wherein the marker is configured to be accessed to resume the consumption of the first multimedia content at the determined point; and
altering an audio component associated with the first multimedia content in response to a change in distance between the first multimedia content and the visible area of the display device based on the first multimedia content being moved away from the visible area of the display device.

25. The machine-readable storage medium of claim 24, wherein the method further comprises:
providing the first multimedia content such that it is visible to the user for at least a portion of a duration of the second computing activity.

26. A system for improving a user's computing experience based on the user's computing activity, the system comprising:
a memory comprising instructions for improving a user's computing experience based on the user's computing activity; and
a processor configured to execute the instructions to:
receive a first indication of a first multimedia content being in a visible area of a display device associated with a first computing device, wherein a first computing activity relates to a consumption of the first multimedia content;
receive a second indication of the first multimedia content being moved away from the visible area of the display device;
receive a third indication of a second activity by the user;
determine, based on at least one of the first indication of the first computing activity or the third indication of the second activity, a point with respect to the first computing activity that corresponds to a change in an attention of the user from the first computing activity on the first computing device to the second activity;
store a marker in a memory based on the determined point, wherein the marker is configured to be accessed to resume the first computing activity at the determined point; and
alter an audio component associated with the first multimedia content in response to a change in distance between the first multimedia content and the visible area of the display device associated with the first computing device based on the first multimedia content being moved away from the visible area on the display device.

27. The system of claim 26, wherein the user is signed into the first computing device and a second computing device, and wherein the second activity corresponds to a second computing activity by the user on the second computing device.

28. The system of claim 27, wherein the second computing activity comprises at least one of initiating an outbound communication or attending to an inbound communication.

29. The system of claim 27, wherein the user is signed into the first computing device using a first set of authentication credentials, and wherein the user is signed into the second computing device using a second set of authentication credentials, and wherein the processor is further configured to:
correlate the first set of authentication credentials with the second set of authentication credentials; and
determine, based on the correlation, that the user signed into the first computing device and the second computing device.

30. The system of claim 29, wherein the first set of authentication credentials corresponds to a first service and the second set of authentication credentials corresponds to a second service.

31. The method of claim 1, wherein the audio component is progressively altered in response to an increase in the distance between the first multimedia content and the visible area of the display device associated with the computing device.

32. The method of claim 1, wherein the first multimedia content is visible in the visible area of the display device, and wherein the first multimedia content is not visible outside of the visible area of the display device.
